(19) United States
(12) Patent Application Publication
(10) Pub. No.: US 2017/0285192 A1
(43) Pub. Date: Oct. 5, 2017

(54) Vibration Monitoring

(71) Applicant: Jeff Barry, Kirkland, WA (US)

(72) Inventor: Jeff Barry, Kirkland, WA (US)

(21) Appl. No.: 15/475,920

(22) Filed: Mar. 31, 2017

Related U.S. Application Data
(60) Provisional application No. 62/316,492, filed on Mar. 31, 2016.

(51) Int. Cl. G01V 1/00; E21B 47/14

(52) U.S. Cl. CPC G01V 1/001; E21B 47/14

(57) ABSTRACT

A buried hydrophone may be configured to identify real-time changes in pipeline acoustics and vibrations during a flood event. Monitoring vibrations may allow predicting the likelihood of pipeline exposure and suspension.

### FIELD

This disclosure relates generally to vibration monitoring.

### BACKGROUND

During a flood event, questions arise as to whether a buried pipeline is about to become exposed or suspended, and whether any operational actions should be considered. A challenge is that traditional monitoring methods, for example, the use of divers, are impractical and unsafe during large flood events.

### SUMMARY

The following presents a simplified summary of the disclosure to provide a basic understanding to the reader. This summary is not an extensive overview of the disclosure, nor does it identify key or critical elements of the claimed subject matter or define its scope. Its sole purpose is to present some concepts disclosed in a simplified form as a precursor to the more detailed description that is later presented.

The instant application discloses, among other things, vibration monitoring. In one embodiment, it may comprise a buried hydrophone or other sensor in direct contact with a pipeline configured to identify real-time changes in pipeline acoustics or vibrations during a flood event. For example, vibration monitoring may determine the likelihood of pipeline exposure and suspension.

Many of the attendant features may be more readily appreciated as they become better understood by reference to the following detailed description considered in connection with the attached drawings.

### BRIEF DESCRIPTION OF THE DRAWINGS

FIG. 1 illustrates a system capable of supporting vibration monitoring, according to one embodiment.

FIG. 2 illustrates a vibration monitoring configuration according to one embodiment.

FIG. 3 illustrates a cross section view of a vibration monitoring test configuration according to one embodiment.

FIG. 4 illustrates a plan view of a vibration monitoring configuration according to one embodiment.

FIG. 5 illustrates a long profile view of a vibration monitoring configuration according to one embodiment.

FIG. 6 illustrates graphs of acoustical results from the experimental design of vibration monitoring described in FIG. 3.

FIG. 7 illustrates a graph of spectral analysis results from the experimental design of vibration monitoring described in FIG. 3.

FIG. 8 illustrates graphs of acoustical results from the experimental design of vibration monitoring described in FIG. 3.

FIG. 9 illustrates a graph showing results from a spectral analysis of acoustical monitoring of sand sediments in the experimental design of vibration monitoring described in FIG. 3.

FIG. 10 illustrates vibration monitoring for pipeline exposure and suspension according to one embodiment.

FIG. 11 is a component diagram of a computing device to which a Vibration Monitoring process may be applied according to one embodiment.

### DETAILED DESCRIPTION

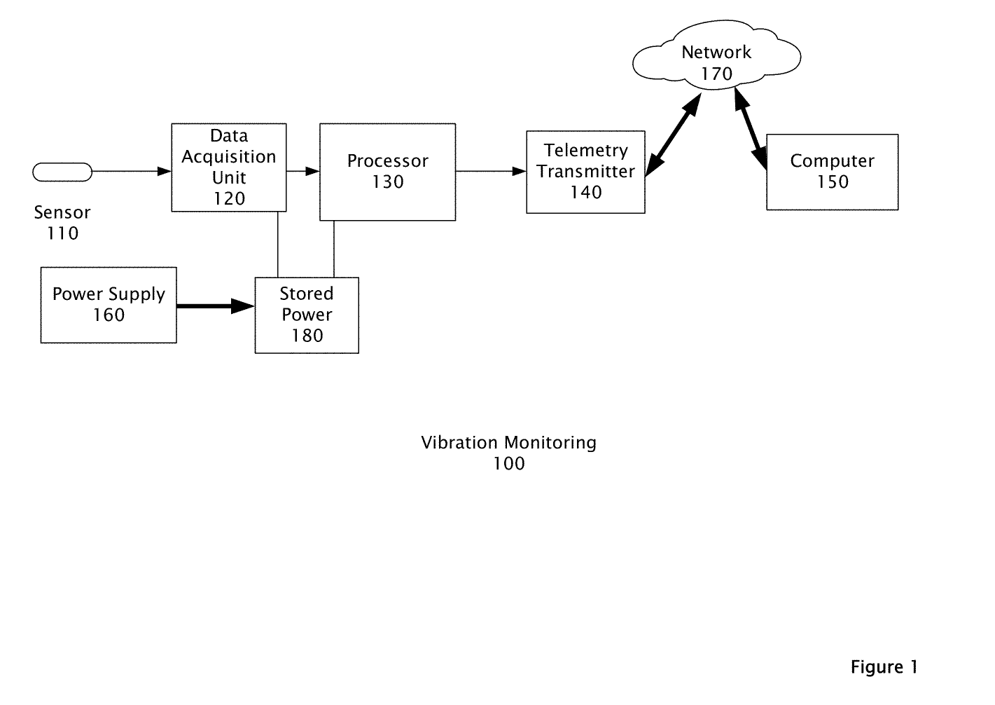

FIG. 1 illustrates a system capable of supporting a remote Vibration Monitoring 100 configuration, according to one embodiment. Sensor 110 may be a hydrophone, and may detect sound waves under water or carried through a pipeline during a flood event. In another embodiment, Sensor 110 may be a vibration sensor, which may detect subsonic vibrations of a pipeline by using an accelerometer or other technology. Sensor 110 may be placed on or near a pipeline, for example. In yet another embodiment, Sensor 110 may include multiple devices. Data Acquisition Unit (DAQ) 120 may receive inputs from Sensor 110, and Processor 130 may convert the inputs into defined outputs, for example, digital numerical values. Telemetry Transmitter 140 may allow automatic collection of data and measurements at remote points and transmission of the measurements and data to receiving equipment, for example, Computer 150, for monitoring. Network 170 may be used to communicate between Telemetry Transmitter 140 and Computer 150. Power Supply 160 may provide energy, for example, electricity, to power Vibration Monitoring 100. Power Supply 160 may use conventional or renewable energy, for example. Stored Power 180 may, for example, be a battery to provide power to components of Vibration Monitoring. Vibration Monitoring 100 may identify real-time changes in pipeline acoustics or other vibrations during a flood event, for example, to determine the likelihood of pipeline exposure and suspension. Frequency and amplitude of the vibrations, as well as changes in vibrations over time, may be used to predict the likelihood of issues for the pipeline.

Network 170 may include Wi-Fi, cellular data access methods, such as 3G or 4GLTE, Bluetooth, Near Field Communications (NFC), the internet, local area networks, wide area networks, or any combination of these or other means of providing data transfer capabilities. In one embodiment, Network 170 may comprise Ethernet connectivity. In another embodiment, Network 170 may comprise fiber optic connections.

Computer 150 may be a smartphone, tablet, laptop computer, smartwatch or intelligent eyewear, or other device, and may have network capabilities to communicate with Telemetry Transmitter 140.

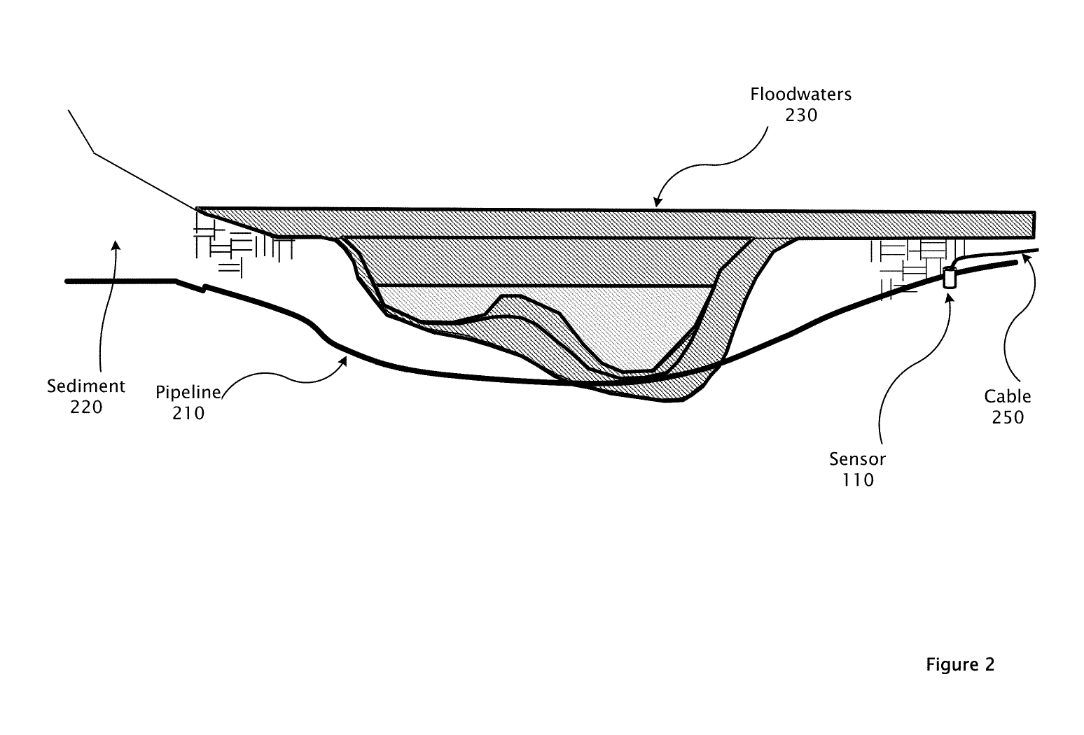

FIG. 2 illustrates a Vibration Monitoring configuration according to one embodiment. In this example, Pipeline 210 may be buried underground, in or beneath Sediment 220 which may include sand, gravel, or other material. Pipeline 210 may carry oil, liquid petroleum, or natural gas, for example. Floodwaters 230 may be fresh water or salt water, and may have various depths. Sensor 110 may be placed on a point on or near Pipeline 210 to detect vibrations or acoustics. Sensor 110 may couple to Cable 250, which may transmit and receive data to and from Computer 150 through Telemetry Transmitter 140.

A reading may be made to determine a baseline vibration or acoustics profile for Pipeline 210 during normal conditions, for example when Pipeline 210 is buried underground or under sediment. When Floodwaters 230 or other issues cause Pipeline 210 to be exposed to flowing water, additional vibrations may be detected from sediment and water hitting Pipeline 210, for example. When differences are detected from the baseline reading, proactive measures may be taken to prevent damage to pipeline. For example, the flow may be shut down or reduced for Pipeline 210.

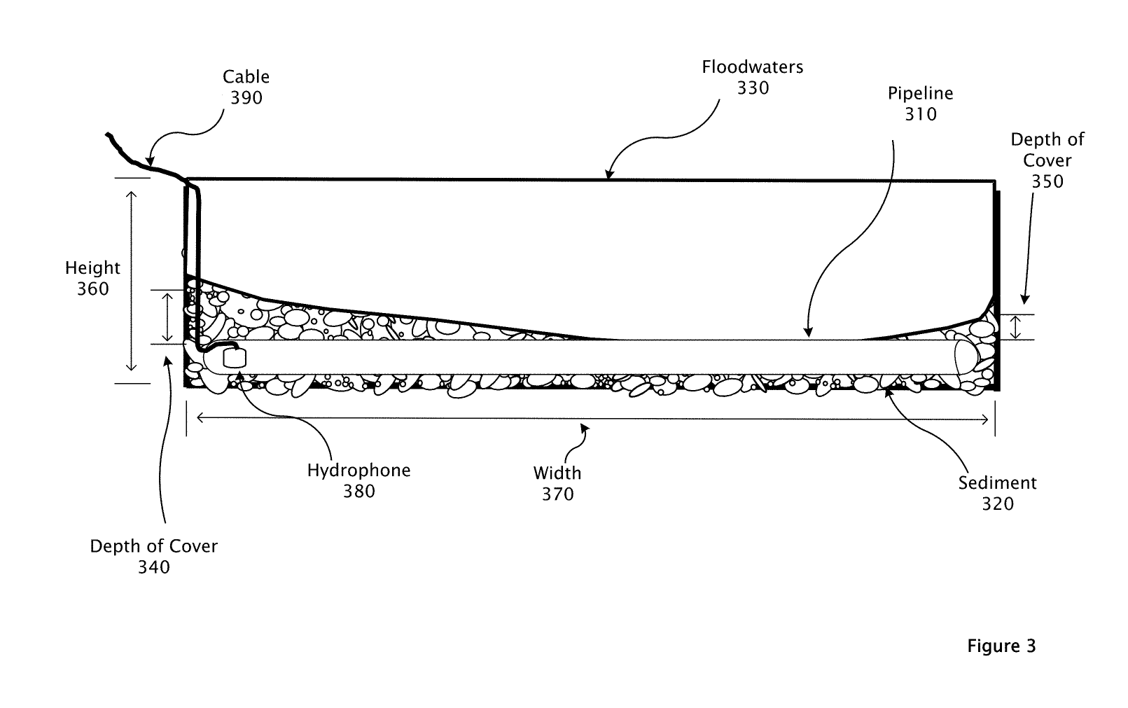

FIG. 3 illustrates a cross section view of a Vibration Monitoring test configuration according to one embodiment. In this example, Pipeline 310 may be a galvanized steel pipe having an outside diameter of approximately 2.4 inches and a wall thickness of 0.1 inches, for example. Sediment 320 may be sand, having an average grain size of less than approximately 1 millimeter, small to medium gravel, with an average grain size of approximately 13 millimeters (small to medium gravel), or coarse gravel having an average grain size of more than approximately 13 millimeters. Sediment 320 may also be other types of sediment, for example, mud or rocks. Floodwaters 330 may have Depth of Cover 340 of approximately 0.5 feet at a first end and Depth of Cover 350 of approximately 0.15 feet at a second end of Pipeline 310. In this example, Height 360 may be approximately 1 foot, and Width 370 may be approximately 4 feet. Hydrophone 380 may be located at one end of Pipeline 310 and may couple to Cable 390.

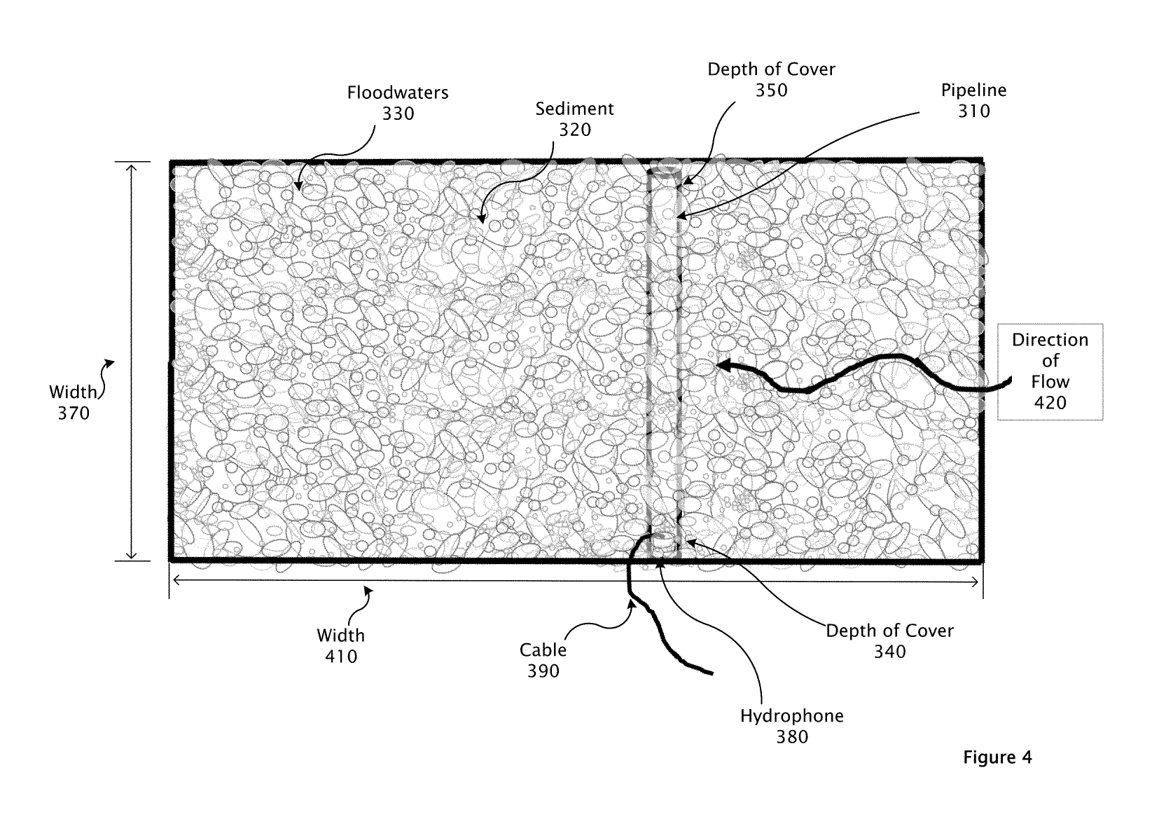

FIG. 4 illustrates a plan view of a Vibration Monitoring test configuration according to one embodiment. Width 410 may be approximately 8 feet and may run in a direction approximately perpendicular to Pipeline 310. Direction of Flow 420 may illustrate movement of Floodwaters 330.

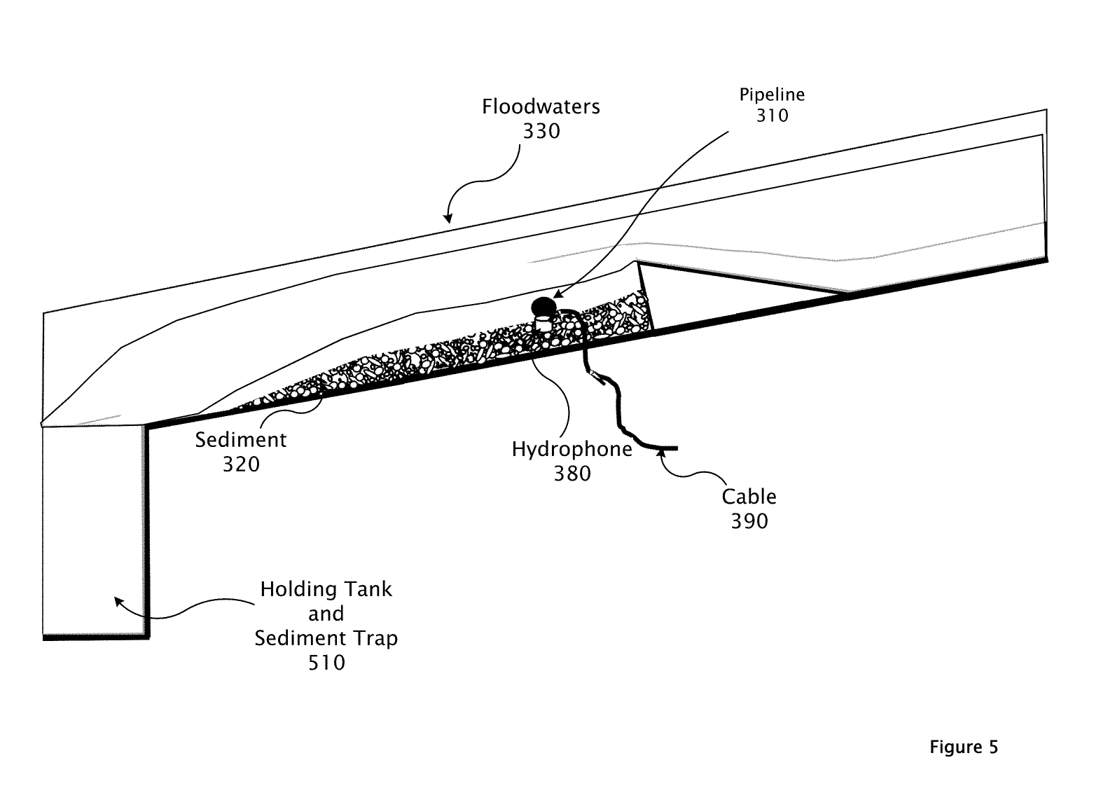

FIG. 5 illustrates a long profile view of a Vibration Monitoring configuration according to one embodiment. Holding Tank and Sediment Trap 510 may be located at a lower elevation from Hydrophone 380 and Cable 390. Holding Tank and Sediment Trap may contain water, for example, an amount of Floodwaters 330 and may filter or hold an amount of Sediment 320.

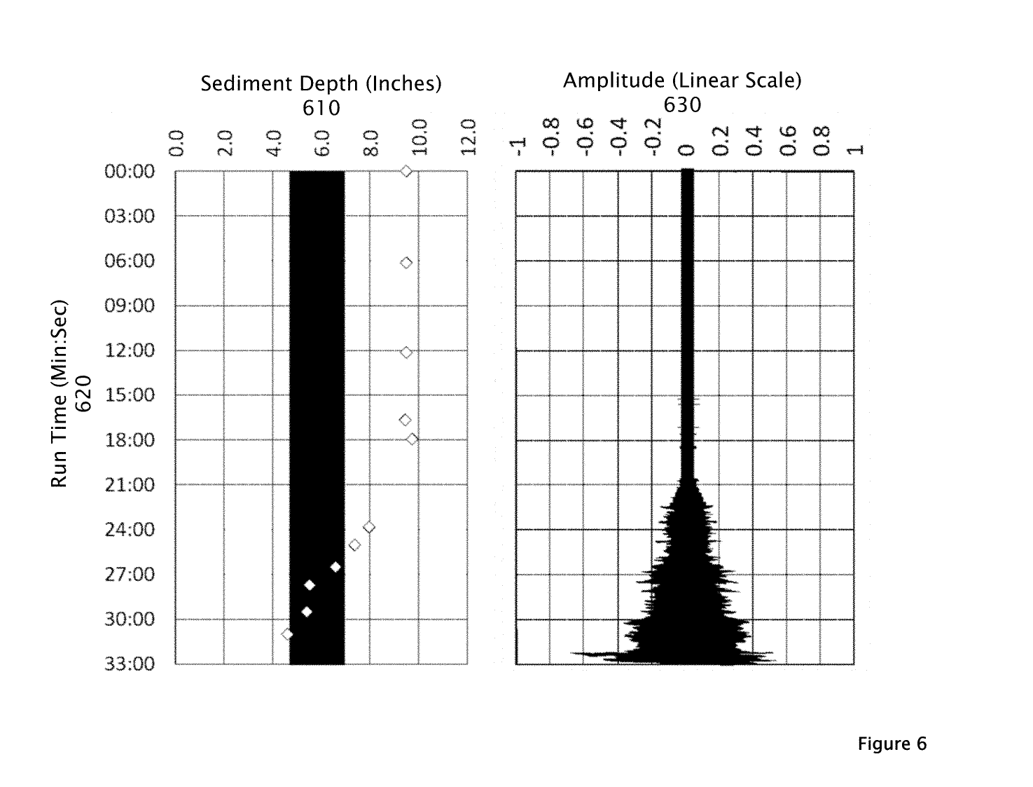

FIG. 6 illustrates graphs of acoustical results from the Vibration Monitoring test configuration described in FIG. 3. Sediment Depth 610, which may be measured in inches, may generally decrease as Run Time 620 increases. Run Time 620 may be measured in minutes and seconds. Amplitude 630, which may be measured on a linear scale may generally increase as Run Time 620 increases.

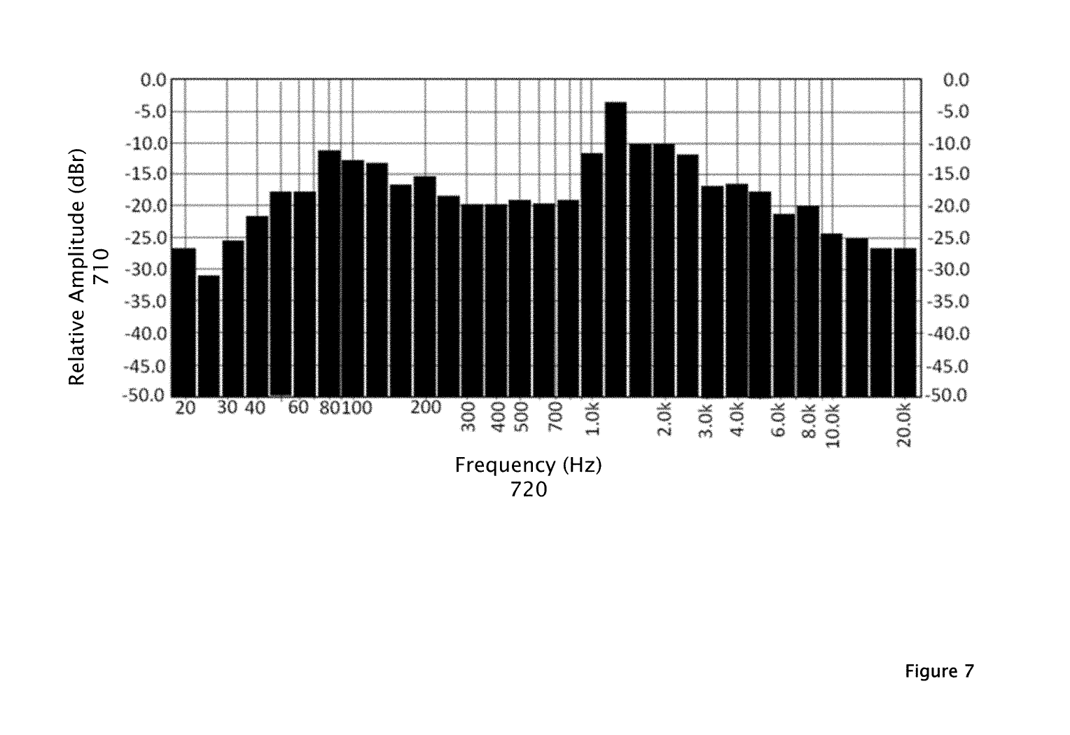

FIG. 7 illustrates a graph of spectral analysis results from the test configuration of Vibration Monitoring described in FIG. 3. Relative Amplitude 710 may be measured in decibels relative to reference level (dBr). Frequency 720 may be measured in hertz (Hz).

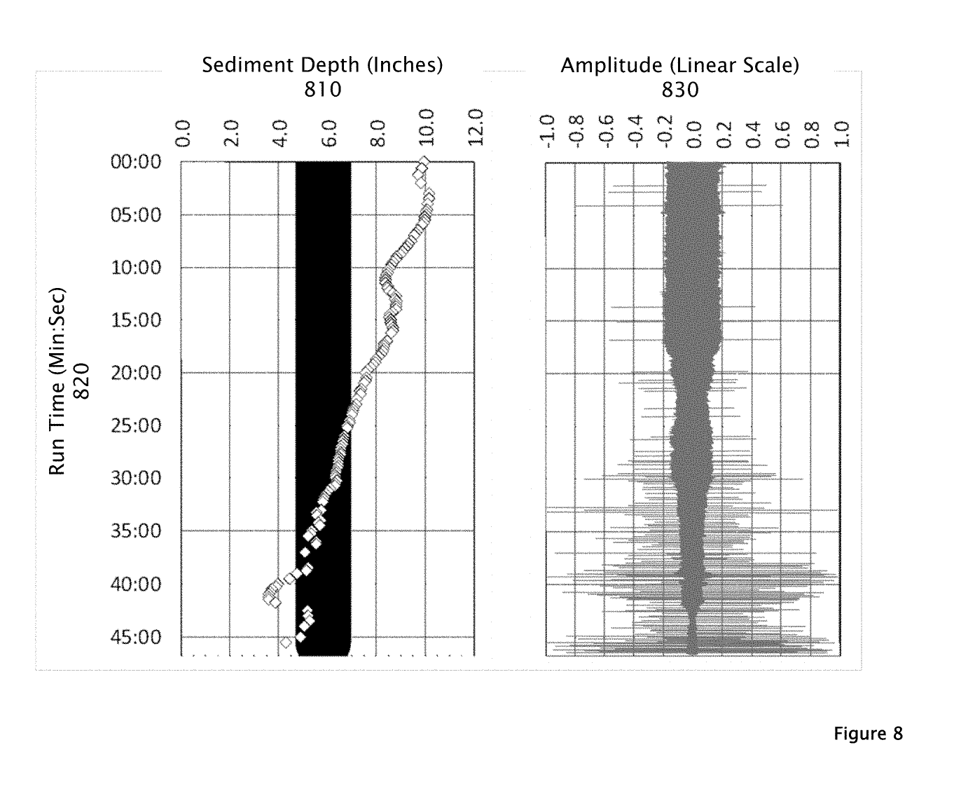

FIG. 8 illustrates graphs of acoustical results from the experimental design of Vibration Monitoring described in FIG. 3. Sediment Depth 810, which may be measured in inches, may generally decrease as Run Time 820 increases. Run Time 820 may be measured in minutes and seconds, for example. Amplitude 830, which may be measured on a linear scale, for example, may generally increase as Run Time 820 increases.

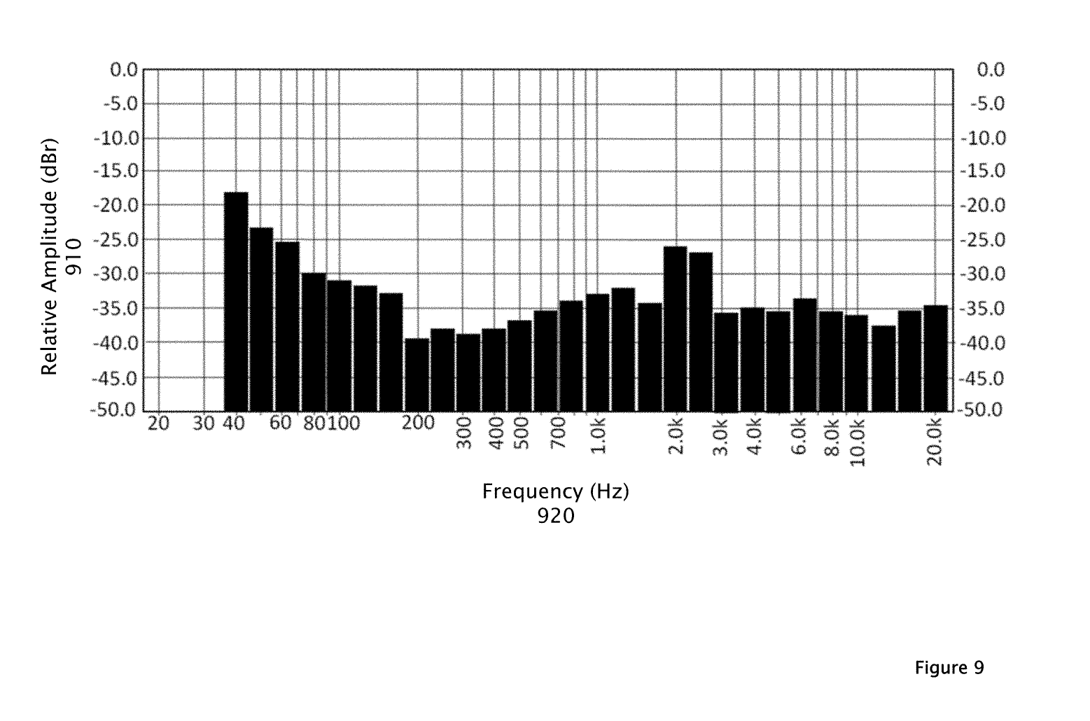

FIG. 9 illustrates a graph showing results from a spectral analysis of sand sediments in the test configuration of Vibration Monitoring described in FIG. 3. Relative Amplitude 910 may be measured in decibels relative to reference level (dBr). Frequency 920 may be measured in hertz (Hz).

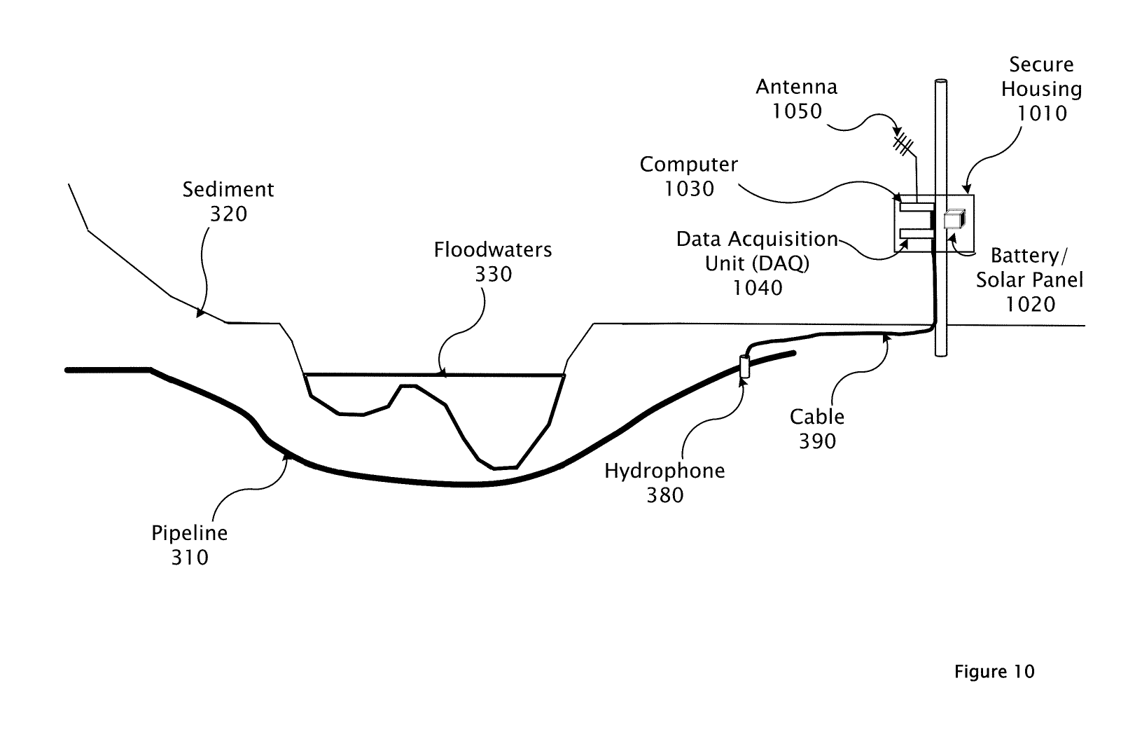

FIG. 10 illustrates Vibration Monitoring for pipeline exposure and suspension according to one embodiment. This example shows a schematic of telemetry design for remote real-time access and control of acoustical data. Secure Housing 1010 may be placed at an elevation, for example, above Pipeline 310, Sediment 320 and Floodwaters 330. Secure Housing 1010 may contain a Battery/Solar Panel 1020. The Battery/Solar Panel 1020 may be a trickle charging solar panel, for example. Secure Housing 1010 may also include Computer 1030, for example, a brick computer which may be used to operate acoustical analysis software. Secure Housing 1010 may also contain Data Acquisition Unit (DAQ) 1040. Antenna 1050 may access, send, and receive data over a mobile or satellite network, for example. In this example, Hydrophone 380 may couple to Cable 390, which may be approximately 30 to 100 meters in length.

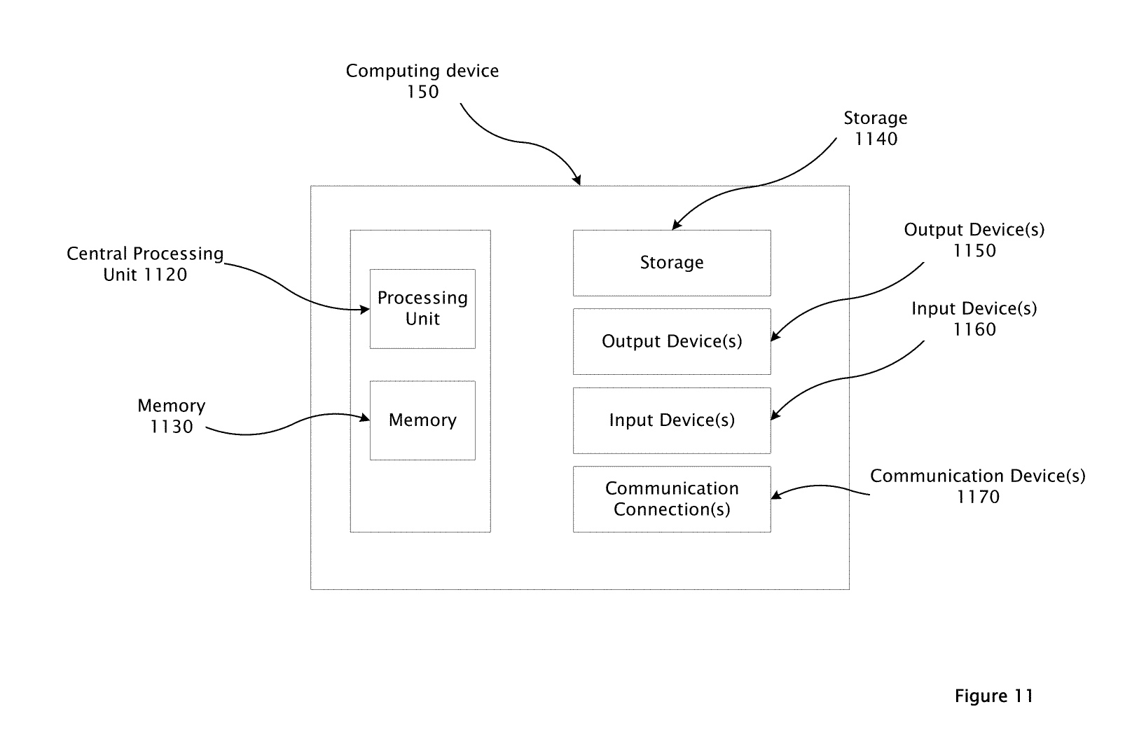

FIG. 11 is a component diagram of a computing device to which a Vibration Monitoring process may be applied according to one embodiment. The Computing Device 150 can be utilized to implement one or more computing devices, computer processes, or software modules described herein, including, for example, but not limited to a mobile device. In one example, the Computing Device 150 can be used to process calculations, execute instructions, and receive and transmit digital signals. In another example, the Computing Device 150 can be utilized to process calculations, execute instructions, receive and transmit digital signals, receive and transmit search queries and hypertext, and compile computer code suitable for a mobile device. The Computing Device 150 can be any general or special purpose computer now known or to become known capable of performing the steps and/or performing the functions described herein, either in software, hardware, firmware, or a combination thereof.

In its most basic configuration, Computing Device 150 typically includes at least one Central Processing Unit (CPU) 1120 and Memory 1130. Depending on the exact configuration and type of Computing Device 150, Memory 1130 may be volatile (such as RAM), non-volatile (such as ROM, flash memory, etc.) or some combination of the two. Additionally, Computing Device 150 may also have additional features/functionality. For example, Computing Device 150 may include multiple CPU's. The described methods may be executed in any manner by any processing unit in Computing Device 150. For example, the described process may be executed by both multiple CPUs in parallel.

Computing Device 150 may also include additional storage (removable or non-removable) including, but not limited to, magnetic or optical disks or tape. Such additional storage is illustrated in FIG. 4 by Storage 1140. Computer readable storage media include volatile and nonvolatile, removable and non-removable media implemented in any method or technology for storage of information such as computer-readable instructions, data structures, program modules or other data. Memory 1130 and Storage 1140 are all examples of computer-readable storage media. Computer readable storage media includes, but is not limited to, RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can accessed by Computing Device 150. Any such computer-readable storage media may be part of Computing Device 150. But computer readable storage media do not include transient signals.

Computing Device 150 may also contain Communications Device(s) 1170 that allow the device to communicate with other devices. Communications Device(s) 1170 is an example of communication media. Communication media typically embody computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media include wired media such as a wired network or direct-wired connection, and wireless media such as acoustic, radio frequency (RF), infrared and other wireless media. The term computer-readable media as used herein includes both computer-readable storage media and communication media. The described methods may be encoded in any computer-readable media in any form, such as data, computer-executable instructions, and the like.

Computing Device 150 may also have Input Device(s) 1160 such as keyboard, mouse, pen, voice input device, touch input device, etc. Output Device(s) 1150 such as a display, speakers, printer, etc. may also be included. All these devices are well known in the art and need not be discussed at length.

Those skilled in the art will realize that storage devices utilized to store program instructions may be distributed across a network. For example, a remote computer may store an example of the process described as software. A local or terminal computer may access the remote computer and download a part or all of the software to run the program. Alternatively, the local computer may download pieces of the software as needed, or execute some software instructions at the local terminal and some at the remote computer (or computer network). Those skilled in the art will also realize that by utilizing conventional techniques known to those skilled in the art that all, or a portion of the software instructions may be carried out by a dedicated circuit, such as a digital signal processor (DSP), programmable logic array, or the like.

While the detailed description above has been expressed in terms of specific examples, those skilled in the art will appreciate that many other configurations could be used. Accordingly, it will be appreciated that various equivalent modifications of the above-described embodiments may be made without departing from the spirit and scope of the invention.

1. A system, comprising:
a sensor, the sensor operable to detect vibrations;
a data acquisition unit, operable to receive input from the sensor;
a processor, operable to receive input from the data acquisition unit;
a telemetry transmitter, operable to receive input from the processor and transmit it to a computer; and
a power supply operable to provide power to the data acquisition unit, the processor, and the telemetry transmitter.

2. The system of claim 1, wherein the sensor is a hydrophone.

3. The system of claim 1, wherein the sensor is a vibration sensor comprising an accelerometer.

4. A method, comprising:
measuring a baseline vibration profile for a pipeline;
sensing a vibration in the pipeline;
detecting a difference between the baseline vibration profile and the sensed vibration in the pipeline; and
predicting a likelihood of pipeline exposure and suspension based on the detected difference.

5. A computer-readable storage device with instructions thereon which, when executed, perform a method comprising:
sensing a vibration in the pipeline;
detecting a difference between a previously measured baseline vibration profile and the sensed vibration in the pipeline; and
predicting a likelihood of pipeline exposure and suspension based on the detected difference.
